(19) United States
(12) Patent Application Publication
(10) Pub. No.: US 2024/0323483 A1
(43) Pub. Date: Sep. 26, 2024

(54) METHOD AND SERVER FOR PROVIDING MEDIA CONTENT

(71) Applicant: SAMSUNG ELECTRONICS CO., LTD., Suwon-si (KR)

(72) Inventors: Jaemin CHUN, Suwon-si (KR); Injung LEE, Suwon-si (KR); Minjin RHO, Suwon-si (KR); Hyunggoog SEO, Suwon-si (KR); Jeongpyo LEE, Suwon-si (KR); Insun HAN, Suwon-si (KR)

(73) Assignee: SAMSUNG ELECTRONICS CO., LTD., Suwon-si (KR)

(21) Appl. No.: 18/652,483

(22) Filed: May 1, 2024

(30) Foreign Application Priority Data
Mar. 24, 2023 (KR) 10-2023-0039067
Apr. 27, 2023 (KR) 10-2023-0055653

(51) Int. Cl. H04N 21/442; G06V 20/40; H04N 21/233; H04N 21/234; H04N 21/422; H04N 21/472

(52) U.S. Cl. CPC H04N 21/44222; G06V 20/40; H04N 21/233; H04N 21/23418; H04N 21/42203; H04N 21/472

(57) ABSTRACT

A method, performed by a server, of providing media content includes: obtaining media content including video data and audio data; obtaining first context data by analyzing the video data; obtaining second context data by analyzing the audio data; based on the first context data and the second context data, generating scene context data corresponding to a plurality of video frames of the media content; determining a user intention for navigating the media content based on a user input; identifying a first at least one video frame of the plurality of video frames corresponding to the user intention based on the scene context data; and outputting the identified first at least one video frame.

### CROSS-REFERENCE TO RELATED APPLICATIONS

This application is a by-pass continuation application of International Application No. PCT/KR2024/003636, filed on Mar. 22, 2024, which is based on and claims priority to Korean Patent Application No. 10-2023-0039067, filed on Mar. 24, 2023, and Korean Patent Application No. 10-2023-0055653, filed on Apr. 27, 2023, in the Korean Intellectual Property Office, the disclosures of which are incorporated by reference herein in their entireties.

### BACKGROUND

### 1. Field

The disclosure relates to a server for providing media content, a system for providing media content, and a method of providing navigation and editing of media content by analyzing media content are provided.

### 2. Description of Related Art

Various types of multimedia content are provided to users through various forms of media. Users may receive multimedia content through their client devices.

Remote control interactions, such as navigation of multimedia content, are performed through control devices such as a remote controller, a keyboard, a mouse, or a microphone, for example. When a user wants to rewind or fast-forward multimedia content, navigation of the multimedia content is accomplished via movement by a preset time interval (for example, 10 seconds forward) or via movement to a preset scene determined by a provider of the multimedia content.

When a user navigates multimedia content, there is a need for a method capable of accurately and conveniently providing scene movement to a free time point according to the user's natural language input, rather than moving to a time point corresponding to a specific time interval or specific time stamp.

### SUMMARY

According to one or more embodiments, a method, performed by a server, of providing media content includes: obtaining media content including video data and audio data; obtaining first context data by analyzing the video data; obtaining second context data by analyzing the audio data; based on the first context data and the second context data, generating scene context data corresponding to a plurality of video frames of the media content; determining a user intention for navigating the media content based on a first user input; identifying a first at least one video frame of the plurality of video frames corresponding to the user intention based on the scene context data; and outputting the identified first at least one video frame.

The media content may include text data, wherein the method may further include obtaining third context data by analyzing the text data, and wherein the generating of the scene context data includes generating the scene context data, further based on the third context data.

The obtaining of the first context data may include: obtaining scene information by applying object recognition to a second at least one video frame of the plurality of video frames; generating at least one scene graph corresponding to the second at least one video frame, based on the scene information; and obtaining the first context data representing context of the video data, based on the at least one scene graph.

The obtaining of the second context data may include: obtaining scene-sound information by applying at least one of voice recognition, sound event detection, or sound event classification to the audio data; and obtaining the second context data representing context of the audio data, based on the scene-sound information.

The obtaining of the third context data may include: obtaining scene-text information by applying natural language processing to the text data; and obtaining the third context data representing context of the text data, based on the scene-text information.

The determining of the user intention for navigating the media content may include: performing automatic speech recognition (ASR), based on the first user input being speech; and determining the user intention by applying a natural language understanding (NLU) algorithm to a result of the automatic speech recognition.

The method may further include, based on a second user input for selecting one video frame from among the identified first at least one video frame, allowing the media content to be played from the selected video frame.

The first user input may include at least one keyword for editing the media content, and the identifying of the first at least one video frame may include identifying a video frame of the plurality of video frames corresponding to the at least one keyword, based on the scene context data.

The method may further include providing a user interface for editing the media content.

The method may further include providing a summary of a result of the editing of the media content.

According to one or more embodiments, a server for providing media content includes: a communication interface, a memory storing one or more instructions, and at least one processor configured to execute the one or more instructions, wherein the at least one processor may be further configured to execute the one or more instructions to: obtain media content including video data and audio data; obtain first context data by analyzing the video data; obtain second context data by analyzing the audio data; based on the first context data and the second context data, generate scene context data corresponding to a plurality of video frames of the media content; determine a user intention for navigating the media content based on a first user input; identify a first at least one video frame of the plurality of video frames corresponding to the user intention based on the scene context data; and output the identified first at least one video frame.

The media content may include text data, and the at least one processor may be further configured to execute the one or more instructions to: obtain third context data by analyzing the text data; and generate the scene context data, further based on the third context data.

The at least one processor may be further configured to execute the one or more instructions to: obtain scene information by applying object recognition to a second at least one video frame of the plurality of video frames; generate at least one scene graph corresponding to the second at least one video frame, based on the scene information; and obtain the first context data representing context of the video data, based on the at least one scene graph.

The at least one processor may be further configured to execute the one or more instructions to: obtain scene-sound information by applying at least one of voice recognition, sound event detection, or sound event classification to the audio data; and obtain the second context data representing context of the audio data, based on the scene-sound information.

The at least one processor may be further configured to execute the one or more instructions to: obtain scene-text information by applying natural language processing to the text data; and obtain the third context data representing context of the text data, based on the scene-text information.

The at least one processor may be further configured to execute the one or more instructions to: perform automatic speech recognition (ASR), based on the first user input being speech; and determine the user intention by applying a natural language understanding (NLU) algorithm to a result of the automatic speech recognition.

The at least one processor may be further configured to execute the one or more instructions to, based on a second user input for selecting one video frame from among the identified first at least one video frame, allowing the media content to be played from the selected video frame.

The first user input may include at least one keyword for editing the media content, and the at least one processor may be further configured to execute the one or more instructions to identify a video frame corresponding to the at least one keyword, based on the scene context data.

The at least one processor may be further configured to execute the one or more instructions to provide a user interface for editing the media content.

According to one or more embodiments, a display device for providing media content includes: a communication interface; a display; a memory storing one or more instructions; and at least one processor configured to execute the one or more instructions, wherein the at least one processor may be further configured to execute the one or more instructions to: obtain media content including video data and audio data; obtain first context data by analyzing the video data; obtain second context data by analyzing the audio data; based on the first context data and the second context data, generate scene context data corresponding to a plurality of video frames of the media content; determine a user intention for navigating the media content based on a first user input; identify a first at least one video frame of the plurality of video frames corresponding to the user intention based on the scene context data; and output the identified first at least one video frame on the display.

According to one or more embodiments, a non-transitory computer-readable recording medium storing one or more instructions, which, when executed by a processor of a server providing media content, may cause the server to: obtain media content comprising video data and audio data; obtain first context data by analyzing the video data; obtain second context data by analyzing the audio data; based on the first context data and the second context data, generate scene context data corresponding to a plurality of video frames of the media content; determine a user intention for navigating the media content based on a user input; identify a first at least one video frame of the plurality of video frames corresponding to the user intention based on the scene context data; and output the identified first at least one video frame.

### DESCRIPTION OF THE DRAWINGS

The above and other aspects, features, and advantages of certain embodiments of the present disclosure are more apparent from the following description taken in conjunction with the accompanying drawings, in which:

FIG. 1 is a diagram schematically showing provision of a media content service by a server, according to one or more embodiments.

FIG. 2 is a flowchart of an operation, performed by a server, of providing a media content service, according to one or more embodiments.

FIG. 3 is a block diagram schematically showing a server obtaining scene context data from media content, according to one or more embodiments.

FIG. 4 is a diagram for describing an operation, performed by a server, of analyzing video data, according to one or more embodiments.

FIG. 5 is a diagram for describing an operation, performed by a server, of analyzing audio data, according to one or more embodiments.

FIG. 6 is a diagram for describing an operation, performed by a server, of analyzing text data, according to one or more embodiments.

FIG. 7 is a diagram for describing scene context data created by a server, according to one or more embodiments.

FIG. 8 is a flowchart of an operation, performed by a server, of navigating media content, based on a user input and a scene context, according to one or more embodiments.

FIG. 9 is a flowchart of an operation, performed by a server, of navigating media content, based on a user input and a scene context, according to one or more embodiments.

FIG. 10 is a diagram illustrating a user navigating to a scene, according to one or more embodiments.

FIG. 11 is a diagram illustrating a user navigating to a scene, according to one or more embodiments.

FIG. 12 is a diagram schematically showing an operation, performed by a user, of editing media content, according to one or more embodiments.

FIG. 13 is a flowchart of an operation, performed by a server, of providing media content editing, according to one or more embodiments.

FIG. 14 is a diagram illustrating a media content editing interface displayed on a user's electronic device.

FIG. 15 is a block diagram of a structure of a server according to one or more embodiments.

FIG. 16 is a block diagram of a structure of a display device according to one or more embodiments.

FIG. 17 is a block diagram of a structure of an electronic device according to one or more embodiments.

### DETAILED DESCRIPTION

Throughout the disclosure, the expression “at least one of a, b or c” indicates only a, only b, only c, both a and b, both a and c, both b and c, all of a, b, and c, or variations thereof.

Although general terms widely used at present were selected for describing the disclosure in consideration of the functions thereof, these general terms may vary according to intentions of one of ordinary skill in the art, case precedents, the advent of new technologies, and the like. Terms arbitrarily selected by the applicant of the disclosure may also be used in a specific case. In this case, their meanings may be given in the detailed description of the disclosure. Hence, the terms must be defined based on their meanings and the contents of the entire specification, not by simply stating the terms.

An expression used in the singular may encompass the expression of the plural, unless it has a clearly different meaning in the context. Unless otherwise defined, all terms (including technical and scientific terms) used herein have the same meaning as commonly understood by one of ordinary skill in the art to which this disclosure belongs. While such terms as “first” or “second”, for example, may be used to describe various components, such components must not be limited to the above terms. The above terms are used only to distinguish one component from another.

The terms “comprises” or “comprising” or “includes” or “including” when used in this specification, specify the presence of stated elements, but do not preclude the presence or addition of one or more other elements. The terms “unit”, “-er (-or)”, and “module” when used in this specification refers to a unit in which at least one function or operation is performed, and may be implemented as hardware, software, or a combination of hardware and software.

One or more embodiments are described in detail herein with reference to the accompanying drawings so that this disclosure may be easily performed by one of ordinary skill in the art to which the disclosure pertains. The disclosure may, however, be embodied in many different forms and should not be construed as being limited to the embodiments set forth herein. In the drawings, parts irrelevant to the description are omitted for simplicity of explanation, and like numbers refer to like elements throughout. In addition, reference numerals used in each drawing are only for describing each drawing, and different reference numerals used in different drawings do not indicate different elements. One or more embodiments will now be described more fully with reference to the accompanying drawings.

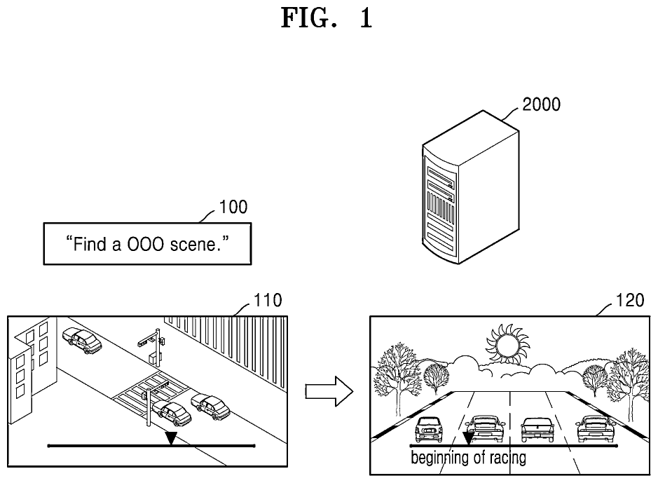

FIG. 1 is a diagram schematically showing provision of a media content service by a server, according to one or more embodiments.

Referring to FIG. 1, a server 2000 may process data related to media content.

According to one or more embodiments, the server 2000 may be a content provider server capable of streaming media content. In this case, the server 2000 may perform analysis of the media content while providing the media content to a display device, which is a client device, and, according to one or more embodiments, may enable a user to receive a navigation/editing function of the media content by using the display device.

According to one or more embodiments, the server 2000 may be a server provided separately from a content provider server that streams media content. In this case, the server 2000 may perform analysis of the media content while obtaining the media content, and, according to one or more embodiments, may enable a user to receive a navigation/editing function of the media content by using the display device.

According to one or more embodiments, the server 2000 may process a user input 100 from a user who watches media content. The user input 100 may be a speech input. However, embodiments of the disclosure are not limited thereto, and the user input 100 may also be an input such as text. The user input 100 may be in the form of a natural language sentence, but is not limited thereto and may also be in the form of keywords. For example, based on the user wanting to navigate to a previous scene while watching media content as displayed on a first screen 110, the user may input the user input 100 in the form of an utterance, for example, a sentence such as “Find a OOO scene.” In this case, the server 2000 may process the user's natural language input to identify the user's intention, and may search for a scene corresponding to the user's intention and provide the found scene to the user.

According to one or more embodiments, the media content may include video data, audio data, or text data, for example. The server 2000 may generate scene context data by analyzing the media content to search for the scene corresponding to the user's intention. The analysis of the media content may be performed through video analysis, audio analysis, text analysis, or a combination thereof.

The server 2000 may accurately and conveniently provide the user's desired navigation point in the media content by processing the user's natural language speech and searching for a corresponding scene, based on scene context data.

Specific operations in which the server 2000 analyzes and processes media content to provide content navigation or content editing will be described in more detail through drawings and their descriptions which will be described later.

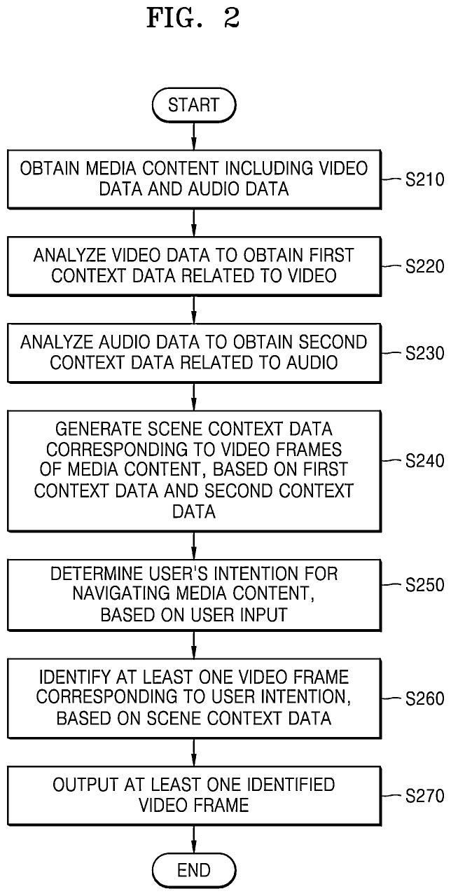

FIG. 2 is a flowchart of an operation, performed by a server, of providing a media content service, according to one or more embodiments.

In operation S210, the server 2000 obtains media content including video data and audio data.

In this disclosure, the media content is referred to as various items of media content including movies, TV programs, documentaries, or other video content, for example, and may also be referred to as multimedia content.

According to one or more embodiments, the media content may be in a digital file format created using a standardized method of packaging media data. For example, the media content may be produced in a media container format such as MP4, AVI, MKV, MOV, or WMV, but the media container format is not limited thereto.

The media content may include various types of media data. For example, the media content may include video data, audio data, and text data (e.g., subtitles). The media data may include metadata indicating detailed information about the media content. The metadata may include, for example, a title, a creator, a duration, a bit rate, a resolution, a video codec, an audio codec, chapter information, and a cover art, but embodiments of the disclosure are not limited thereto.

The server 2000 allows a user (content viewer) to navigate or edit the media content. The media content is played back on the user's display device.

In operation S220, the server 2000 analyzes the video data to obtain first context data related to video. The first context data represents the context of the video, and may also be referred to as video context data.

The server 2000 may analyze the video data in various ways.

The server 2000 may perform a downsampling operation of selecting video frames that are to be analyzed from among video frames constituting the video data. For example, 60 fps video may include 60 video frames per second. In this case, the server 2000 may extract only one video frame per second and use the extracted one video frame as a frame to be analyzed.

The server 2000 may detect at least one object within the video frame. The server 2000 may recognize the category of the at least one object detected from the video frame. The server 2000 may detect a relationship between recognized objects. The server 2000 may use one or more artificial intelligence (AI) models to achieve object detection, object recognition, and object relationship detection. For example, the server 2000 may use an object detection model, an object recognition model, and an object relationship detection model, which are AI models.

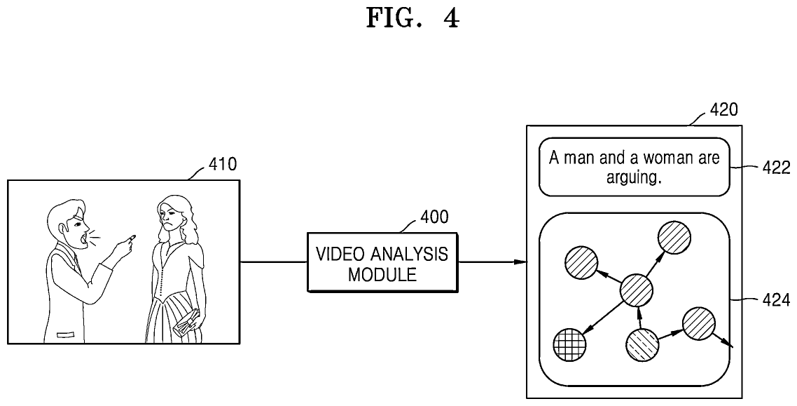

The server 2000 may generate a scene graph, based on resultant data resulting from object detection, object recognition, and object relationship detection. The server 2000 may also generate a video context, based on the scene graph. An operation, performed by the server 2000, of analyzing video data will be further described with reference to FIG. 4.

In operation S230, the server 2000 analyzes the audio data to obtain second context data related to audio. The second context data represents the context of the audio, and may also be referred to as audio context data.

The server 2000 may analyze the audio data in various ways to obtain scene-sound information. The scene-sound information represents pieces of information related to a sound corresponding to a scene (video frame) within the media content.

The server 2000 may extract text representing a conversation, for example, from the audio data by using automatic speech recognition (ASR) or voice recognition. The server 2000 may use a natural language processing (NLP) model for automatic speech recognition. The NLP model may be an AI model that receives audio including spoken words and outputs text as a transcript of the audio.

The server 2000 may detect or classify a sound event in the audio data. The server 2000 may use a sound event classification model, which is an AI model, to classify the sound event.

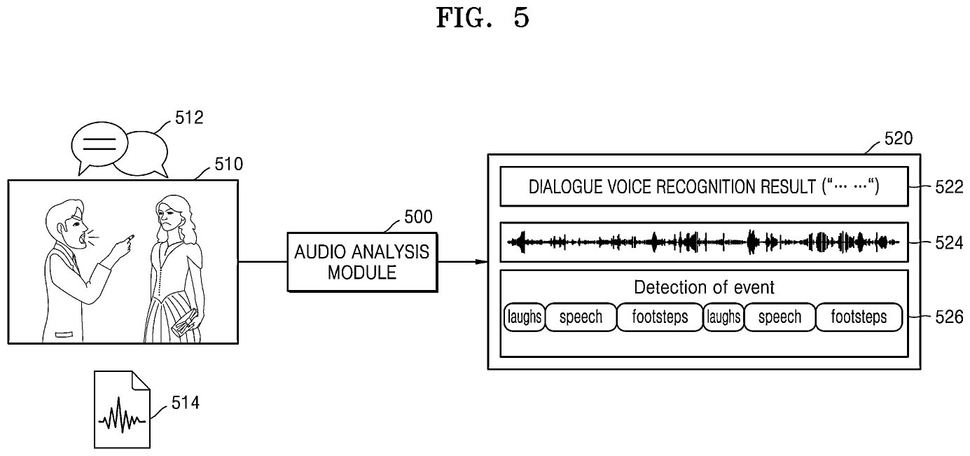

The server 2000 may generate an audio context, based on the scene-sound information obtained through audio analysis. An operation, performed by the server 2000, of analyzing audio data will be further described with reference to FIG. 5.

In operation S240, the server 2000 generates scene context data corresponding to the video frames of the media content, based on the first context data and the second context data. The first context data may be referred to as video context data, and the second context data may be referred to as audio context data.

The server 2000 may generate scene context data corresponding to each of the video frames included in the media content.

According to one or more embodiments, the scene context data refers to data organized in a data format that may be used to understand and interpret a visual scene. The scene context data may include, but is limited to, scene identification numbers, categories of objects present in a scene, locations of the objects, spatial relationships between objects, attributes of objects, information about interactions between objects, and other information representing the scene.

For example, in the scene context data, objects in a scene may be a “person” and a “car”. Location information (bounding box) of each object may be [x1, y1, x2, y2] for “person” and [x3, y3, x4, y4] for “car”. A spatial relationship between “person” and “car” may be “next to”. The other information representing the scene may include, but is not limited to, the type of the scene “outdoor”, the weather of the scene “clear”, and the time zone of the scene “night”.

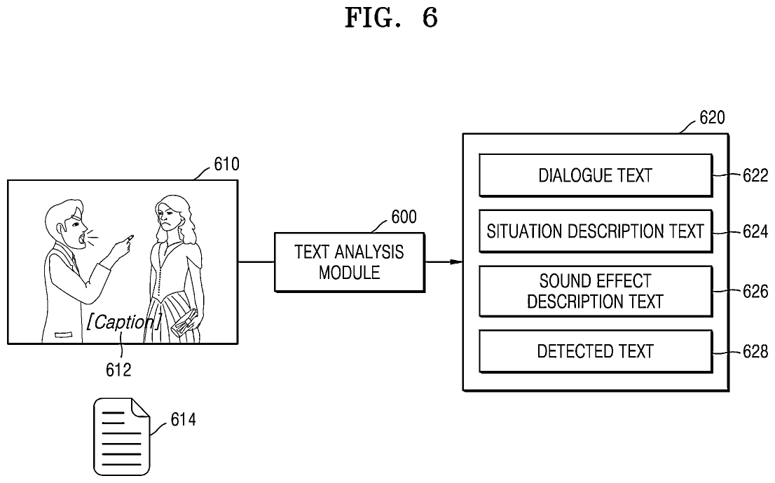

When the media content includes the text data, the server 2000 may obtain text context data. When generating the scene context data, the server 2000 may generate the scene context data by further using the text context data in addition to the above-described examples. An operation, performed by the server 2000, of analyzing text data will be further described with reference to FIG. 6.

In operation S250, the server 2000 determines a user's intention for navigating the media content, based on a user input.

According to one or more embodiments, the user input may be a natural language speech input. In response to the user's speech input, the server 2000 may determine the user's intention by using the NLP algorithm. The server 2000 may perform automatic speech recognition on the user's utterance and apply a natural language understanding algorithm to a result of the automatic speech recognition to thereby determine the user's intention for navigating the media content. The user's intention for navigating the media content may be, for example, “search for a scene”, “go back forward”, and “skip back”, but embodiments of the disclosure are not limited thereto. For example, based on the user utterance being “Show me the explosion scene from earlier”, the user intention for navigating the media content may be “Search for the explosion scene”.

The user input is not limited to a natural language speech. For example, the user input may be a text input such as “Show me the explosion scene from earlier”.

In operation S260, the server 2000 identifies at least one video frame corresponding to the user intention, based on the scene context data.

When the user's intention is determined, the server 2000 may search for scene context data corresponding to the user's intention. Continuing to explain the example described above in operation S250, the user's intention may be determined as “search for an explosion scene”, based on the user uttering a request to show an explosion scene. The server 2000 may search for a scene corresponding to the user's intention within the media content. For example, one or more explosion scenes “Explosion Scene A”, “Explosion Scene B”, or “Explosion Scene C”, included in the media content may be searched. In this case, the server 2000 may identify at least one video frame corresponding to “explosion scene A”, “explosion scene B”, and “explosion scene C”.

In operation S270, the server 2000 outputs the at least one identified video frame.

The server 2000 may transmit the at least one identified video frame to a display device on which the media content is played back. In this case, the server 2000 may provide information (e.g., a time stamp of a video frame) related to the at least one identified video frame. In this case, one or more identified video frames may be displayed on the display device. For example, frames corresponding to “Explosion Scene A”, “Explosion Scene B”, and “Explosion Scene C”, respectively, may be displayed.

The display device may navigate the media content, based on the user input. For example, based on the user selecting a video frame representing “Explosion Scene A” displayed on the display device, the display device may allow the user to move to a time zone of “Explosion Scene A” within a video timeline and then play back video from “Explosion Scene A”.

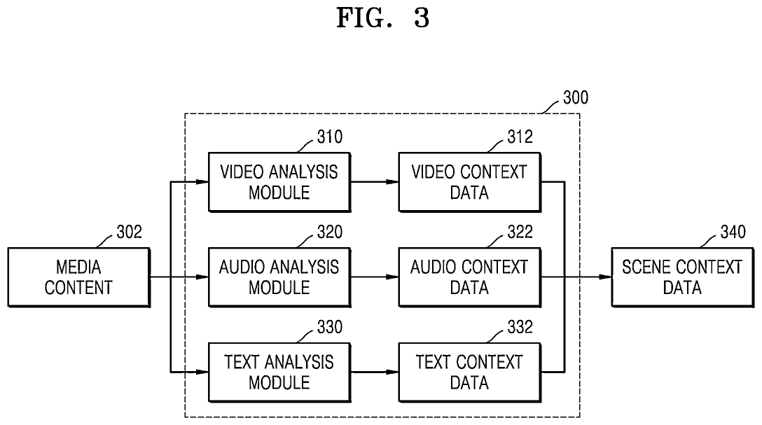

FIG. 3 is a block diagram schematically showing obtainment of scene context data from media content by a server, according to one or more embodiments.

According to one or more embodiments, the server 2000 may analyze media content 302 by using a scene analysis module 300. The scene analysis module 300 may include a video analysis module 310, an audio analysis module 320, and a text analysis module 330.

The video analysis module 310 may analyze video data to obtain video context data 312. The server 2000 may apply object detection or object recognition to at least some of the video frames and obtain scene information, by using the video analysis module 310. The server 2000 may generate a scene graph corresponding to at least one video frame, based on the scene information. For example, the server 2000 may generate “Scene Graph A” corresponding to “Scene A” and “Scene Graph B” corresponding to “Scene B”. The server 2000 may obtain video context data 312, which represents the context of video, based on the scene graph. According to one or more embodiments, the server 2000 may obtain the scene graph as the video context data 312.

The audio analysis module 320 may analyze audio data to obtain audio context data 322. The server 2000 may apply at least one of voice recognition, sound event detection, or sound event classification to the audio data and obtain scene-sound information, by using the audio analysis module 320. The scene-sound information refers to information related to audio context, which is obtained from a sound corresponding to a scene. The server 2000 may obtain audio context data 322, which represents the audio context, based on the scene-sound information.

The text analysis module 330 may analyze text data to obtain text context data 332. The server 2000 may apply an NLP algorithm to the text data and obtain scene-text information, by using the text analysis module 330. The scene-text information refers to information related to text context, which is obtained from text corresponding to the scene. The server 2000 may obtain the text context data 332, which represents the text context, based on the scene-text information.

The scene analysis module 300 may obtain scene context data 340, based on at least one of the video context data 312, the audio context data 322, or the text context data 332. The scene context data 340 may correspond to one or more video frames. For example, “Scene A” may consist of one or more video frames. For the one or more video frames corresponding to “Scene A”, the video context data 312, the audio context data 322, and the text context data 332 may be obtained. In this case, the server 2000 may create “Scene Context A” as a scene context corresponding to “Scene A”.

Respective operations of the video analysis module 310, the audio analysis module 320, and the text analysis module 330 of the scene analysis module 300 will be described in more detail with reference to FIGS. 4 through 6, respectively.

FIG. 4 is a diagram for describing an operation, performed by a server, of analyzing video data, according to one or more embodiments.

Referring to FIG. 4, the server 2000 may perform video analysis by using a video analysis module 400. The video analysis module 400 may extract scene information 420 from a video frame 410. The video analysis module 400 may be configured to use various algorithms for video analysis. The video analysis module 400 may include one or more AI models.

According to one or more embodiments, the server 2000 may detect at least one object within the video frame 410 by using the video analysis module 400. The server 2000 may use an object detection model, which is an AI model, to achieve object detection. The object detection model may be a deep neural network model that receives an image and outputs information representing detected objects. For example, the object detection model may receive an image and output bounding boxes representing detected objects. The object detection model may be implemented by using various known deep neural network architectures and algorithms, or through modifications of the various known deep neural network architectures and algorithms. The object detection model may be implemented, for example, as a Faster R-CNN, a Mask R-CNN, a You Only Look Once (YOLO), and a Single Shot Detector (SSD) based on convolutional neural networks (CNNs). However, embodiments of the disclosure are not limited thereto.

According to one or more embodiments, the server 2000 may recognize the category of the at least one object detected within the video frame 410 by using the video analysis module 400. The server 2000 may use an object recognition model, which is an AI model, to achieve object recognition. The object recognition model may be a deep neural network model that receives an image and outputs information representing an object class label(s). For example, the object recognition model may receive an image obtained by cropping an object and output one or more object class labels (e.g., a “car” and a “person”) and a confidence score. The object recognition model may be implemented by using various known deep neural network architectures and algorithms, or through modifications of the various known deep neural network architectures and algorithms. The object recognition model may be implemented, for example, as a ResNet, Inception Networks, VGG Networks, or a DenseNet based on CNNs, but embodiments of the disclosure are not limited thereto.

According to one or more embodiments, the server 2000 may detect a relationship between recognized objects by using the video analysis module 400. The server 2000 may use an object relationship detection model, which is an AI model, to detect the relationship between objects. The object relationship detection model may be a deep neural network model that receives information about the detected objects and outputs information representing the relationship between objects. For example, the object relationship detection model is a model that receives information about detected objects “roof” and “person” and outputs a relationship “on top of” between the two objects that indicates that the person is on top of the roof. The object relationship detection model may be implemented by using various known deep neural network architectures and algorithms, or through modifications of the various known deep neural network architectures and algorithms. The object relationship detection model may be implemented, for example, as a Graph R-CNN or Neural Motifs based on Graph Neural Networks (GNNs), but embodiments of the disclosure are not limited thereto.

The server 2000 may create the scene information 420 by using data obtained through the above-described examples. For example, the server 2000 may create a scene caption 422 for the video frame 410. For example, the server 2000 may create a scene graph 424 for the video frame 410. The scene graph 424 may include one or more nodes and one or more edges. One or more nodes of the scene graph 424 represent one or more objects, and one or more edges thereof represent relationships between one or more objects. The scene information 420 obtained by the server 2000 through video analysis is not limited to the aforementioned examples. The server 2000 may extract various pieces of information related to the scene, which may be extracted through video analysis.

The server 2000 may generate video context data, based on the scene information 420. For example, the server 2000 may generate the video context data representing the context of video by processing at least one of the scene caption 422 or the scene graph 424, which are elements in the scene information 420, or selecting and packaging data elements.

FIG. 5 is a diagram for describing an operation, performed by a server, of analyzing audio data, according to one or more embodiments.

Referring to FIG. 5, the server 2000 may extracting various features related to audio (e.g., a sound size, a pitch, a beat, and a duration) and analyze the audio, by using the audio analysis module 500. The audio analysis module 500 may extract scene-audio information 520 from audio corresponding to a video frame 510. The audio corresponding to the video frame 510 may include, for example, a dialogue 512, a sound event 514, but embodiments of the disclosure are not limited thereto. The audio analysis module 500 may be configured to use various algorithms for audio analysis. The audio analysis module 500 may include one or more AI models.

According to one or more embodiments, the server 2000 may recognize a dialogue by using the audio analysis module 500. The server 2000 may use an NLP model to achieve dialogue recognition. The NLP model refers to an algorithm that processes and analyzes a human language. NLP may include automatic speech recognition. Automatic speech recognition refers to transcription of a spoken language into written text. An automatic speech recognition model may be implemented as, for example, Hidden Markov Models (HMMs), Deep Neural Networks (DNNs), Recurrent Neural Networks (RNNs), and Transformer-based Models, but embodiments of the disclosure are not limited thereto. The server 2000 may transcribe the spoken language into text and process the text, by using an NLP model. For example, the server 2000 may generate an output, such as text classification, translation, or summarization.

According to one or more embodiments, the server 2000 may detect or classify a sound event in audio data by using the audio analysis module 500. For example, the server 2000 may obtain a spectrogram of the audio data. The server 2000 may use a sound event classification model to classify the sound event. The sound event classification model may be a deep neural network model that receives a spectrogram and outputs a class label(s) of the sound event. The server 2000 may identify a specific sound event such as speech, music, or noise (e.g., “dog barking” or “car horn”) by using the sound event classification model. The sound event classification model may be implemented by using various known deep neural network architectures and algorithms, or through modifications of the various known deep neural network architectures and algorithms. The sound event classification model may be implemented as Convolutional Neural Networks (CNNs), Convolutional-Recurrent Neural Networks (CRNNs), or Attention-based models, but embodiments of the disclosure are not limited thereto.

The server 2000 may create the scene-audio information 520 by using data obtained through the above-described examples. The scene-audio information 520 refers to information extracted/generated from audio corresponding to a scene. For example, the server 2000 may generate a dialogue voice recognition result 522 corresponding to at least one video frame. For example, the server 2000 may generate an audio spectrogram 524 corresponding to the at least one video frame. For example, the server 2000 may generate a sound event detection result 526 corresponding to the at least one video frame.

The scene-audio information 520 obtained by the server 2000 through audio analysis is not limited to the aforementioned examples. The server 2000 may extract various pieces of information related to the audio of a scene, which may be extracted through audio analysis.

For example, the server 2000 may separate the audio data into a plurality of audio sources. The server 2000 may separate the audio data into audio sources, such as “speech”, “music”, and “sound effects”, and analyze each of the audio sources.

For example, the server 2000 may analyze the dialogue to generate the scene-audio information 520 including speech contents and emotions of a character. For example, the server 2000 may analyze music to identify the mood of the music, instrument information thereof or generate scene-audio information 520 representing information of the music (e.g., a title and an artist). For example, the server 2000 may analyze sound effects to generate scene-audio information 520 representing the mood (e.g., a tension, a relief, and a joy) of the scene.

The server 2000 may generate audio context data, based on the scene-audio information 520. For example, the server 2000 may generate the audio context data representing the context of audio by processing at least one of the dialogue voice recognition result 522, the audio spectrogram 524, or the sound event detection result 526, which are elements in the scene-audio information 520, or selecting and packaging data elements.

FIG. 6 is a diagram for describing an operation, performed by a server, of analyzing text data, according to one or more embodiments.

Referring to FIG. 6, the server 2000 may perform text analysis by using a text analysis module 600. The text analysis module 600 may extract scene-text information 620 from text corresponding to a video frame 610. The scene-text information 620 refers to information extracted/generated from text corresponding to a scene. The text corresponding to the video frame 610 may include, for example, a caption 612, metadata 614 (e.g., performer names and chapter names) of media content, but embodiments of the disclosure are not limited thereto. The text analysis module 600 may be configured to use various algorithms for text analysis. The text analysis module 600 may include one or more AI models.

According to one or more embodiments, the caption 612 may include text representing dialogue between characters within the media content. According to one or more embodiments, the caption 612 may include text that describes situations or features, for example, of the media content for viewers who are hard of hearing. For example, the caption 612 may include text indicating background sounds, situations, or effect sounds, such as “calm music flows”, “car horn sound”, and “laughter sound”. The metadata 614 of the media content may include text indicating, for example, performer names, or chapter names. The server 2000 may perform text classification, translation, summarization, or detection on the text included in the video frame 610, the caption 612, the metadata 614, and the like, and generate the scene-text information 620, by using an AI model (e.g., an NLP model or a text detection model). Because an AI model for text processing may be implemented through adoption or modification of various known neural network architectures, a detailed description thereof will be omitted.

For example, the scene-text information 620 may include dialogue text 622 between characters in the scene. The scene-text information 620 may include situation description text 624 (e.g., “two main characters are fighting”). The scene-text information 620 may also include sound effect description text 626 (e.g., “laughter sound” and “explosion sound”). The scene-text information 620 may also include detected text 628. The detected text 628 may be obtained using a text detection model, based on text being included within the video frame 610.

The scene-text information 620 obtained by the server 2000 through text analysis is not limited to the aforementioned examples. The server 2000 may extract various pieces of information related to the text of the scene, which may be extracted through text analysis.

The server 2000 may generate text context data, based on the scene-text information 620. For example, the server 2000 may generate the text context data representing the context of the text by processing at least one of the dialogue text 622, the situation description text 624, the sound effect description text 626, or the detected text 628, which are elements in the scene-text information 620, or selecting and packaging data elements.

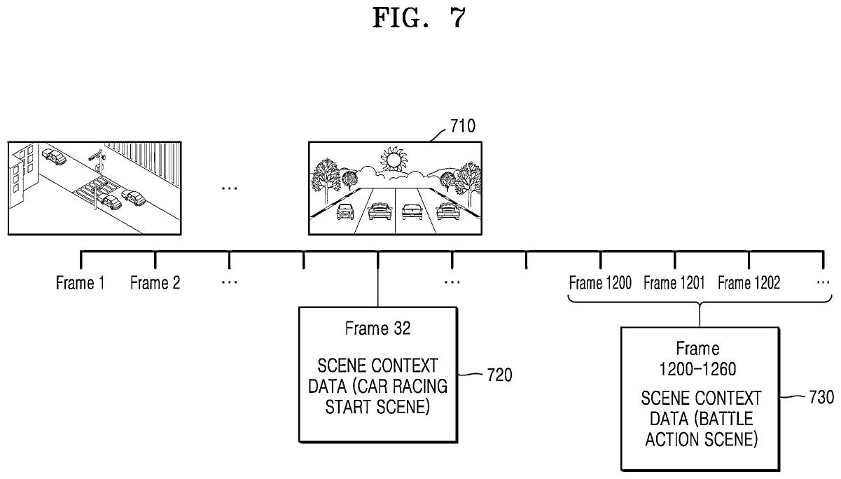

FIG. 7 is a diagram for describing scene context data created by a server, according to one or more embodiments.

According to one or more embodiments, the server 2000 may obtain the scene context data, based on at least one of video context data, audio context data, or text context data. As a result, video frames included in media content have scene context data corresponding to the video frames.

Referring to FIG. 7, a 32^{nd} video frame 710 may be a car racing start scene. In this case, based on the server 2000 generating the scene context data according to one or more embodiments, scene context data 720 of the car racing start scene may be obtained. The scene context data 720 of the car racing start scene may correspond to the 32^{nd} video frame 710. In this case, pieces of data representing a scene-related context of the 32^{nd} video frame 710, such as “the number of cars”, “car location”, “dark background’, “night time zone”, and “car racing start”, may be included in the scene context data 720 of the car racing start scene.

Likewise, scene context data corresponding to another scene may be generated for the other scene. For example, 1200th through 1260th video frames may be a portion of a battle action scene. In this case, based on the server 2000 generating the scene context data according to one or more embodiments, scene context data 730 of the battle action scene may be obtained. According to one or more embodiments, based on there being no scene change, the same scene context data may correspond to video frames classified into the same scene. For example, the scene context data 730 of the battle action scene may correspond to all of the 1200th through 1260th video frames classified into a portion of the battle action scene.

According to one or more embodiments, the server 2000 may receive a user input for navigating to a scene within the media content, and search for the scene to be navigated by a user by using scene context data.

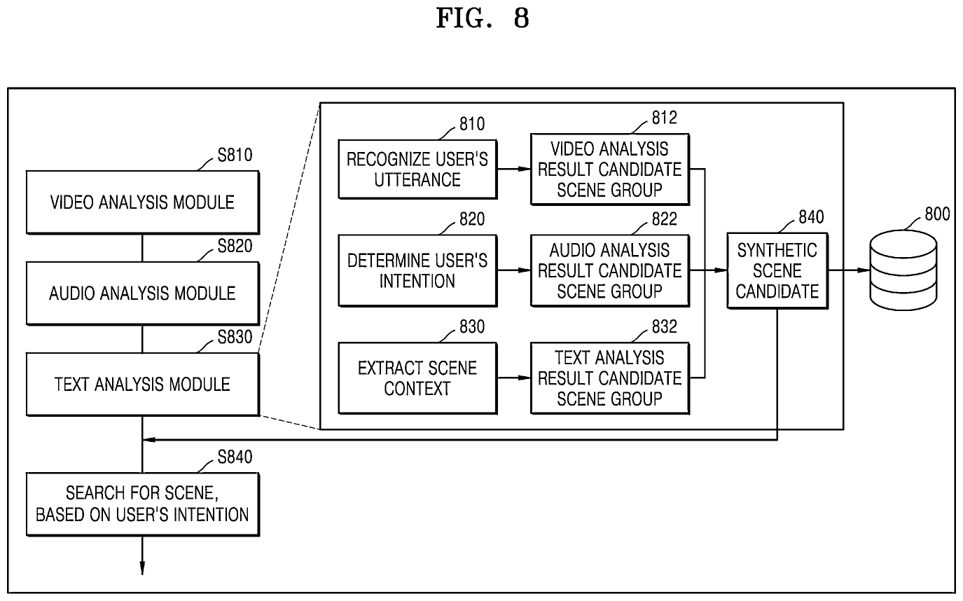

For example, while the media content is being streamed, the server 2000 may receive the user input for navigating to a scene within the media content. In response to the user input, the server 2000 may obtain a scene context by analyzing the media content, and may search for a scene context corresponding to the user input. The analysis of the media content may include the above-described video analysis, the above-described audio analysis, and the above-described text analysis. A detailed description thereof will be further described with reference to FIG. 8.

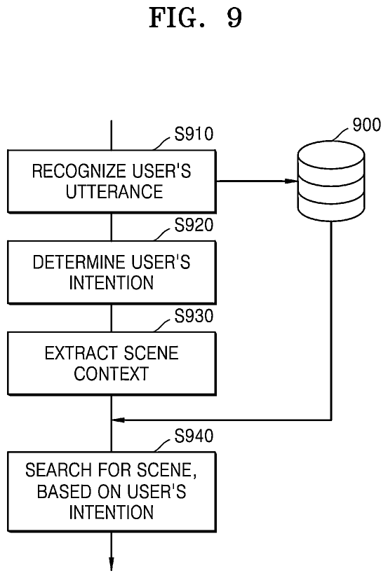

For example, the server 2000 may obtain pre-stored media content (e.g., downloaded media content), and analyze the media content to obtain the scene context in advance. When the user input is received while the media content is being played back, the server 2000 may search for a scene context corresponding to the user input. A detailed description thereof will be further described with reference to FIG. 9.

FIG. 8 is a flowchart of an operation, performed by a server, of navigating media content, based on a user input and a scene context, according to one or more embodiments.

In operation S810, the server 2000 recognizes a user's utterance.

The server 2000 may receive a user input. The server 2000 may perform automatic voice recognition to change a spoken language into written text, based on the user input being speech.

In operation S820, the server 200 determines a user's intention.

The server 2000 may determine the user's intention by applying a natural language understanding algorithm to the text resulting from the automatic speech recognition. In this case, a natural language understanding model may be used. The natural language understanding model may include, for example, processes such as “tokenization”, which separates text into individual units such as a sentence and a phrase, “part-of-speech tagging”, which identifies and tags parts of speech such as nouns, verbs, and adjectives, “entity recognition”, which identifies and classifies entities named in a dictionary, such as a name, a date, and a location, “dependency parsing”, which identifies a grammatical relationship between words in a sentence, “sentiment analysis”, which determines the emotional tone of text classified into positive, negative, or neutral, for example, in a sentence, and “intention recognition”, which identifies the intention of the text.

For example, the server 2000 may determine that the user's intention is to navigate to a car racing scene, based on a user's utterance, which is “Would you like to watch this car racing again from the beginning?”.

In operation S830, the server 2000 extracts a scene context.

When an utterance from the user is recognized and the user's intention to navigate the media content is extracted while the media content is being streamed, the server 2000 may perform a scene context extraction task for the media content currently being played back in real time. For example, the server 2000 may identify scene candidates of a car racing scene.

According to one or more embodiments, based on the server 2000 performing a scene context extraction task in real time, the server 2000 may analyze the media content for a preset time section. For example, the server 2000 may analyze media content in a time zone of 30 seconds before and after a current time point.

The server 2000 may perform video analysis and obtain video context data, by using a video analysis module 810. The server 2000 may determine a video analysis result candidate scene group 812, which is a result of identifying one or more scenes corresponding to the user's intention, based on the video context data. For example, the video analysis result candidate scene group 812 may include “video frame A”, “video frame B”, and “video frame C”.

The server 2000 may perform audio analysis and obtain audio context data, by using an audio analysis module 820. The server 2000 may determine an audio analysis result candidate scene group 822, which is a result of identifying one or more scenes corresponding to the user's intention, based on the audio context data. For example, the audio analysis result candidate scene group 822 may include “video frame B”, “video frame D”, and “video frame F”.

Likewise, the server 2000 may obtain text context data and determine a text analysis result candidate scene group 832, which is a result of identifying one or more scenes corresponding to the user's intention, by using a text analysis module 830. For example, the text analysis result candidate scene group 832 may include “video frame B”, “video frame C”, and “video frame E”.

The server 2000 may determine a synthetic scene candidate 840 by synthesizing respective results of video analysis, audio analysis, and text analysis with one another. In the above example, a video frame common to video analysis, audio analysis, and text analysis is “video frame B”. Accordingly, “video frame B”, which is highly likely to be a car racing scene, may be determined as the synthetic scene candidate 840.

In operation S840, the server 2000 searches for a scene, based on a user's intention.

Based on the synthetic scene candidate 840, the server 2000 may transmit scene-related information to the user's display device so that the user may navigate to the scene. For example, the server 2000 may search for a car racing scene, and may allow “Video Frame B”, which represents a beginning portion of the car racing scene, to be displayed on the user's display device. In this case, the user may watch the car racing scene again by selecting “video frame B” displayed on the display device.

The server 2000 may store the scene context obtained during the media content analysis process, in a database 800.

According to one or more embodiments, the server 2000 may determine the analysis range of the media content, based on the user's intention obtained from the user's utterance. For example, based on the user utterance being “I want to watch the car racing a minute ago again from the beginning.”, the user's intention is to navigate to a car racing scene, but, because the user utterance includes a word “a minute ago”, the server 2000 may obtain a scene context only for scenes included in a previous timeline from a currently-being-played video frame. For example, based on the user utterance being “This scene is a bit boring.”, the server 2000 may identify that the user's intention is to skip the current scene. Accordingly, the server 2000 may obtain scene context only for scenes included in a subsequent timeline from the currently-being-played video frame, so that the user may skip the current scene. The server 2000 may first identify the user's intention, perform analysis of the media content, based on the user's intention, and extract a scene context corresponding to the user's intention, thereby improving computational efficiency compared to first extraction of only the scene context in batches.

In FIG. 8, media analysis and scene context extraction start based on a user utterance being input and recognized. However, this is for convenience of explanation. For example, based on streaming of the media content beginning, the server 2000 may analyze the streaming media content in real time to obtain the scene context and store the same in the database 800.

FIG. 9 is a flowchart of an operation, performed by a server, of navigating media content, based on a user input and a scene context, according to one or more embodiments.

In operation S910, the server 2000 extracts a scene context. The server 2000 may obtain pre-stored media content (e.g., downloaded media content), and analyze the media content to obtain the scene context in advance. The obtained scene context may be stored in a database 900.

In operation S920, the server 2000 may recognize a user's utterance. In operation S930, the server 2000 determines a user's intention. Because operations S920 and S930 may correspond to operations S810 and S820 of FIG. 8, repeated descriptions thereof are omitted for brevity.

In operation S940, the server 2000 searches for a scene, based on the user's intention.

The server 2000 may use the scene context stored in the database 900. For example, based on the user uttering “This scene is a bit boring.”, the server 2000 may identify the user's intention to skip the current scene, and, based on the scene context, may search for a non-boring scene (e.g., an action scene), based on the scene context.

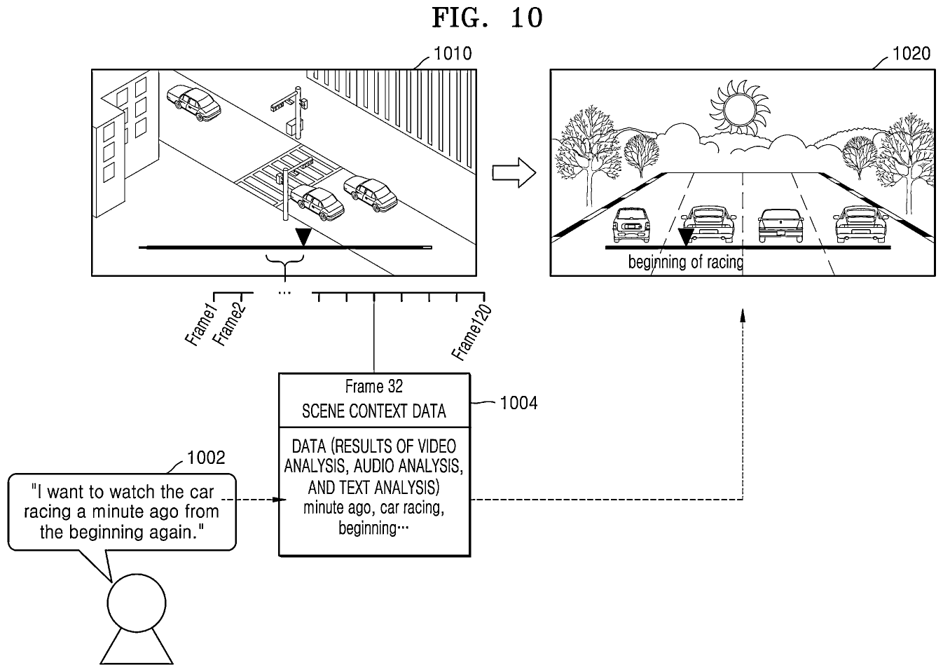

FIG. 10 is a diagram illustrating a user navigating to a scene, according to one or more embodiments.

Referring to FIG. 10, a user may watch media content through a display device. A first screen 1010 of the display device shows an action scene in which cars are racing. A second screen 1020 of the display device shows a scene of a car race beginning.

According to one or more embodiments, the server 2000 may obtain a user input 1002. For example, the user input 1002 may be a spoken language, “I want to watch the car racing a minute ago from the beginning again.” The server 2000 may identify the user's intention through NLP, and may search for a scene corresponding to the identified user's intention. For example, the server 2000 may identify that the user wants to search for a scene in a time period earlier than the present, based on the words “a minute ago”, and that the user wants to search for a scene of a race about to start, based on “car racing” and “the beginning”. The server 2000 may identify at least one video frame corresponding to the user's intention, based on scene context data obtained through media content analysis. For example, the server 2000 may identify that scene context data 1004 of “video frame 32” is a scene corresponding to the user's intention, and may output “video frame 34” as a search result.

The server 2000 according to one or more embodiments may obtain detailed scene contexts for the scenes of the media content through media content analysis including video analysis, audio analysis, and text analysis. The server 2000 may precisely identify the user's intention to navigate the media content, through NLP.

For example, based on the user uttering “Why is the main character angry?”, the server 2000 may identify the user's intention, and may search for a scene in which the main character argues with another person, which is the trigger for the main character to become angry.

For example, based on the user uttering “Who is that person?”, the server 2000 may identify the user's intention, and search for a scene in which the person on the screen appears for the first time.

For example, based on the user uttering “This part is too boring.”, the server 2000 may identify the user's intention, and search for a scene other than the scene to which the user responded as a boring part.

For example, based on the user uttering “Go back to the scene where the black van exploded on the bridge earlier.”, the server 2000 may identify the user's intention and search for the scene in which the black van exploded on the bridge.

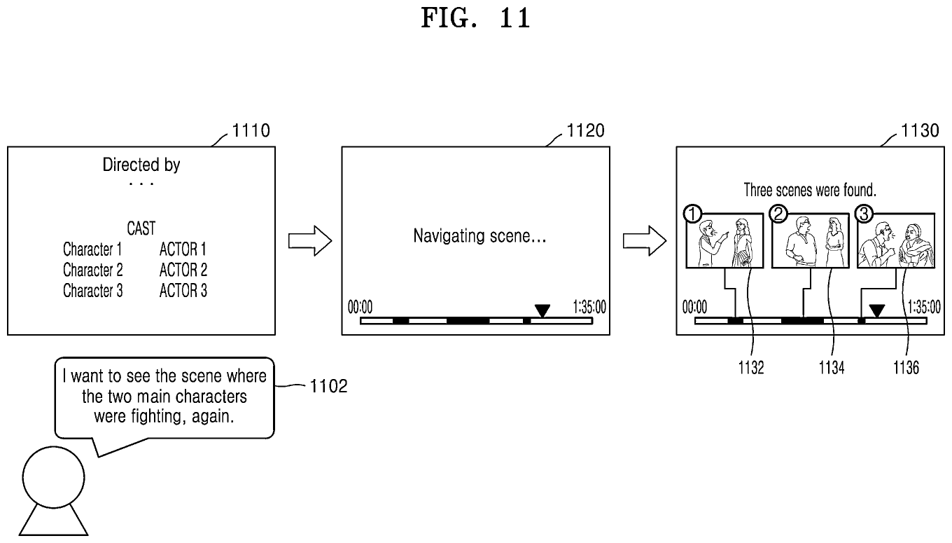

FIG. 11 is a diagram illustrating a user navigating to a scene, according to one or more embodiments.

Referring to FIG. 11, the user may watch media content through a display device. A first screen 1110 of the display device shows that reproduction of the media content ends and ending credits are displayed. A second screen 1120 of the display device shows that the display device is processing a scene search based on an user input. A third screen 1130 of the display device shows a result of identifying at least one video frame corresponding to a user's intention.

According to one or more embodiments, a user input 1102 may be a natural language input of “I want to see the scene where the two main characters were fighting, again.” The server 2000 may identify the user's intention through NLP and search for a scene corresponding to the user's intention.

For example, the server 2000 may search for a scene 1132 in which a main character A and a main character B fight each other, a scene 1134 in which a main character C and a supporting character D fight each other, and a scene 1136 in which supporting characters E and F fight each other. The server 2000 may provide scene search results to the display device. The display device may display a search result corresponding to the user's intention, based on information received from the server 2000.

According to one or more embodiments, the server 2000 may perform media content analysis in parallel while the media content is being played, and may obtain and store scene context data. In this case, based on the user input 1102 being received after the media content ends, the server 2000 may identify a video frame corresponding to the user's intention, based on the stored scene context data.

According to one or more embodiments, the server 2000 may start analyzing the media content, in response to a user input. The server 2000 may obtain scene context data through media content analysis, and may identify a video frame corresponding to the user's intention, based on the obtained scene context data.

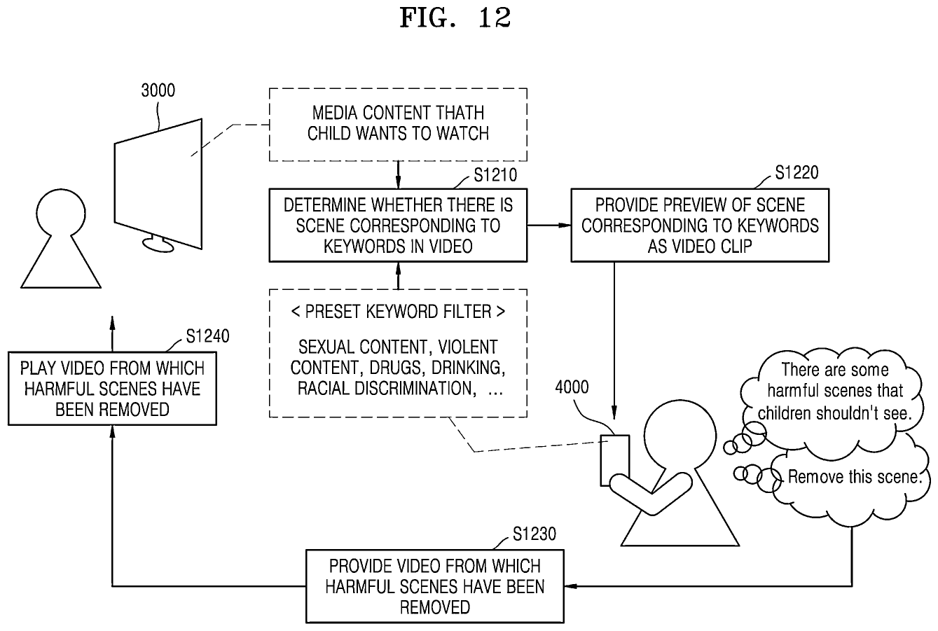

FIG. 12 is a diagram schematically showing an operation, performed by a user, of editing media content, according to one or more embodiments.

According to one or more embodiments, the server 2000 may allow the user to search for scenes and edit the media content. In the descriptions of FIGS. 12 through 14, an embodiment of editing harmful scenes for children will be described as an example in which a user edits media content. However, this is only an example for convenience of explanation, and the editing of the media content is not limited to the editing of harmful scenes for children.

In operation S1210, the server 2000 determines whether there is a scene corresponding to keywords in a video. For example, based on a child wanting to watch media content by using a display device 3000, the server 2000 may search for a scene from the media content, based on preset keywords. The preset keywords may be set by a user input for editing media content. The preset keywords may include natural language sentences, phrases, or words, for example. The preset keywords may include, for example, sexual content, violent content, drugs, drinking, or racial discrimination, for example, but embodiments of the disclosure are not limited thereto.

The server 2000 may perform at least one of video analysis, audio analysis, or text analysis on the media content, and may obtain scene context data for each scene.

In operation S1220, the server 2000 may provide a preview of the scene corresponding to the keywords as a video clip. For example, the server 2000 may provide a user interface for editing the media content. The user interface for editing the media content may be displayed on an electronic device 4000 (e.g., a smartphone) of the user. The server 2000 may transmit data related to the user interface for editing the media content to the user's electronic device 4000.

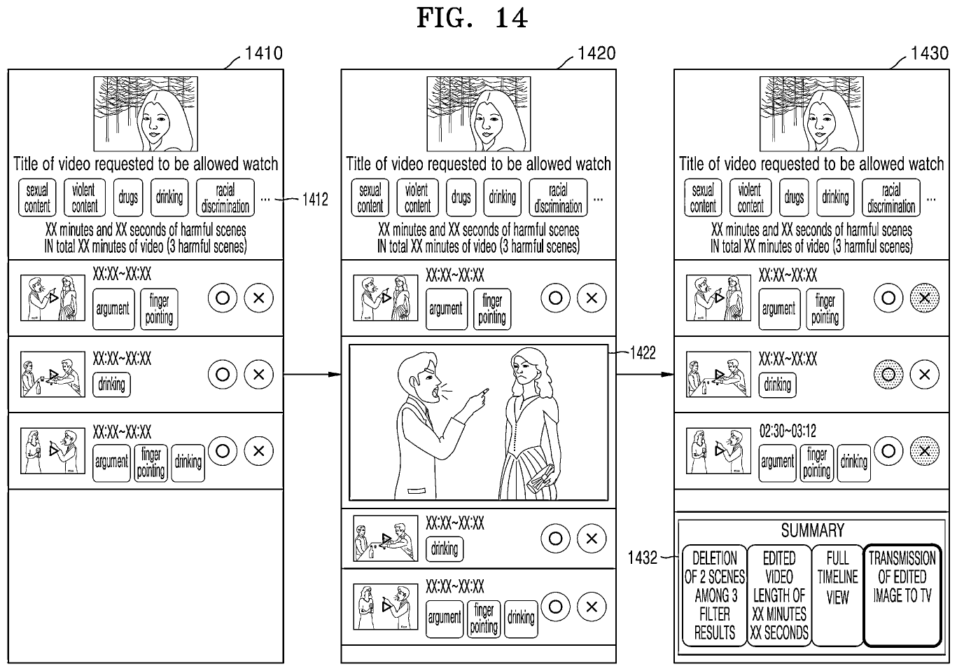

The user interface for editing the media content may display information about the media content, video clip previews, keyword search results, and editing or non-editing, but embodiments of the disclosure are not limited thereto. The user interface for editing the media content will be further described with reference to FIG. 14.

In operation S1230, the server 2000 provides a video from which harmful scenes have been removed. The server 2000 may receive an input for editing the media content from the user's electronic device 4000, and may edit the media content, based on the received input. In the example of FIG. 12, removing harmful scenes refers to editing media content.

In operation S1240, the server 2000 enables playback of the video from which harmful scenes have been removed. The video from which harmful scenes have been removed may be played back on the display device 3000.

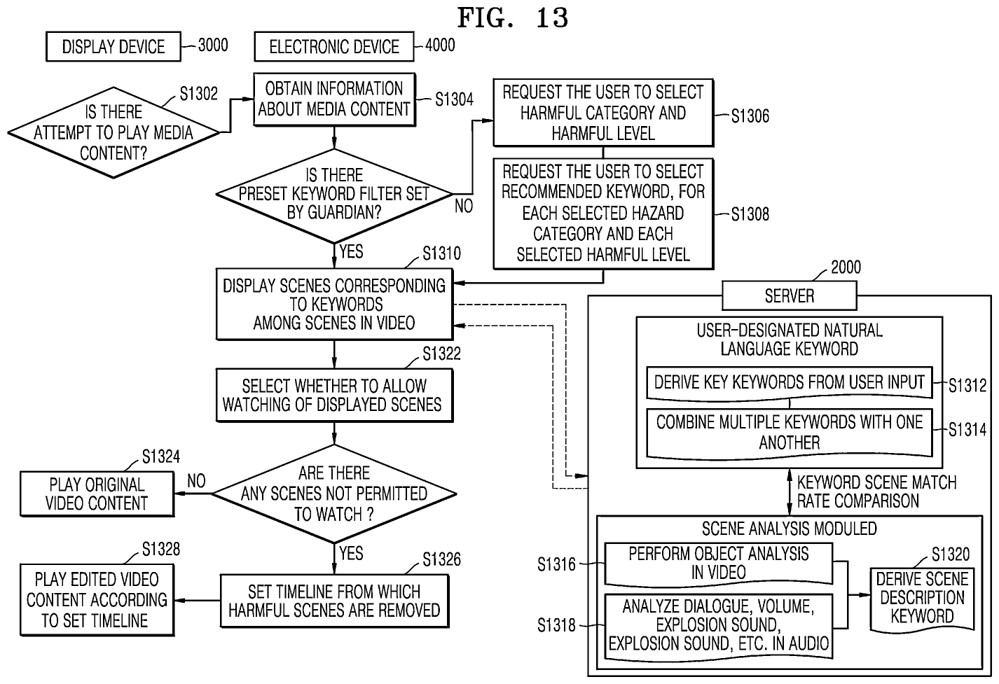

FIG. 13 is a flowchart of an operation, performed by a server, of providing media content editing, according to one or more embodiments.

One or more embodiments illustrated in FIG. 12 will be described in more detail with reference to FIG. 13. According to one or more embodiments, the description will be made assuming that the display device 3000 is a device through which a child wants to watch media content, and the electronic device 4000 is a device of a parent/guardian who wants to edit harmful scenes.

The display device 3000 identifies whether there is an attempt to play the media content (S1302). When an attempt is made to play the media content, the display device 3000 may transmit, to the electronic device 4000 or the server 2000, information that there is a request to play the media content.

The electronic device 4000 obtains information about the media content attempted to be played (S1304). The electronic device 4000 may receive the information about the media content from the display device 3000 or the server 2000.

According to one or more embodiments, editing of the media content may be necessary for a child to watch the media content, but there may not be a preset keyword filter for editing the media content. In this case, the electronic device 4000 may recommend a keyword for editing harmful scenes. For example, the electronic device 4000 may request the user to select a harmful category and a harmful level (S1306). The electronic device 4000 may also request the user to select a recommended keyword, based on the selected hazard category and harmful level (S1308).

According to one or more embodiments, for the media content, there may be keyword filters that are preset by the guardian. Preset keywords may be set by a user input. The preset keywords may include, for example, sexual content, violent content, drugs, drinking, or racial discrimination, for example, but embodiments of the disclosure are not limited thereto. The preset keywords may include not only words but also natural language inputs.

The electronic device 4000 displays scenes corresponding to keywords among the scenes in a video (S1310). Information about the scenes corresponding to the keywords in the video may be received from the server 2000. The server 2000 may transmit the information about the scenes corresponding to the keywords within the media content to the electronic device 4000, through operations S1312 through S1320, which will be described later.

The server 2000 derives key keywords from the user input (S1312). For example, based on the user input being “I want to delete scenes with blood.”, the server 2000 may derive key keywords, such as “blood”, “violence”, “battle”, and “murder”, through NLP. Alternatively, based on the user input being a keyword such as “blood”, the server 2000 may derive “blood” and keywords related to “blood”, such as “violence”, “battle”, and “murder”, as key keywords. The server 2000 combines multiple keywords with one another (S1314).

The server 2000 performs object analysis in the video (S1316). Because the server 2000 obtaining video context data by analyzing the video has been described above, repeated explanations thereof will be omitted.

The server 2000 analyzes a dialogue, a volume, or an explosion sound, for example, in audio (S1318). Because the server 2000 obtaining audio context data by analyzing the audio has been described above, repeated explanations thereof will be omitted.

The server 2000 derives scene description keywords (S1320). The server 2000 may obtain scene context data, based on video context data and audio context data. Because this has already been described above, a redundant description thereof will be omitted.

When the media content includes text data, the server 2000 may generate text context data by performing text analysis, and may further use the text context data to generate scene context data.

The server 2000 may identify the scenes corresponding to the keywords within the media content, by comparing a combination of multiple keywords obtained based on the user input with the scene description keywords.

The electronic device 4000 selects whether to allow watching of the displayed scenes (S1322). Whether watching is allowed may mean that, based on the user of the electronic device 4000 allowing watching, found scenes are maintained within the media content, and, based on the user of the electronic device 4000 not allowing watching, the found scenes are deleted from the media content.

When there are no scenes for which viewing is not permitted, the original video content is played on the display device 3000 (S1324).

When there are scenes that are not allowed to be watched, the electronic device 4000 sets a timeline from which harmful scenes are removed (S1326). The electronic device 4000 may transmit a time section determined by the user to be a harmful scene to the server 2000, and the server 2000 may delete scenes corresponding to a set time section. In this case, edited video content is played according to a timeline set in the display device 3000 (S1328).

FIG. 14 is a diagram illustrating a media content editing interface displayed on a user's electronic device.

According to one or more embodiments, the server 2000 may provide the electronic device 4000 with a user interface for editing media content. The electronic device 4000 may display, on its screen, the user interface for editing the media content.

Referring to a first screen 1410 of the user's electronic device 4000, the first screen 1410 may display information about the media content, set keywords 1412, scene search results, video clip previews, keyword search results, and editing or non-editing, but embodiments of the disclosure are not limited thereto. Referring to the first screen 1410, a result of searching for a scene corresponding to a keyword, a first scene search result, a second scene search result, and a third scene search result may be displayed. For example, referring to the third scene search result, a thumbnail of a found scene, a time section of the found scene, a keyword of the found scene, or an edit button, for example, may be included.

The user may preview the video of the found scene. By selecting the thumbnail of the found scene, the user may directly check which scene the found scene is related to. For example, referring to a second screen 1420 of the electronic device 4000, based on the user selecting a video preview, the video preview may be provided through a screen 1422 within the screen.

According to one or more embodiments, the server 2000 may provide the electronic device 4000 with a summary of a result of the media content editing. Referring to a third screen 1432 of the electronic device 4000, the electronic device 4000 may display, on the screen, an editing result summary window 1432 indicating the summary of the result of the media content editing.

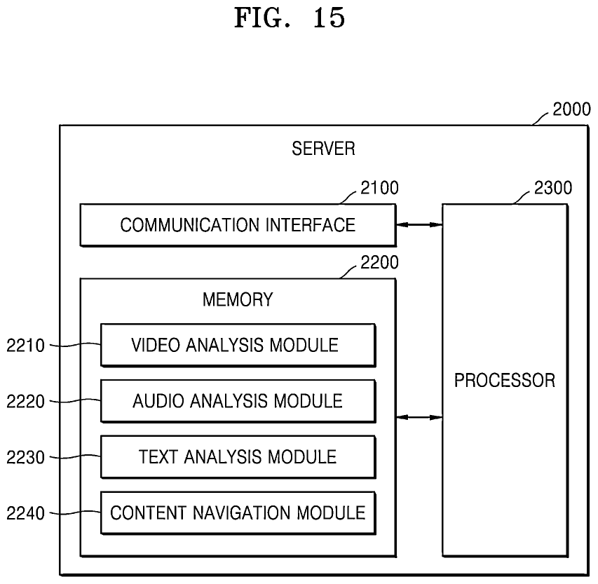

FIG. 15 is a block diagram of a structure of the server 2000 according to one or more embodiments.

According to one or more embodiments, the server 2000 may include a communication interface 2100, a memory 2200, and a processor 2300.

The communication interface 2100 may include a communication circuit. The communication interface 2100 may include a communication circuit capable of performing data communication between the server 2000 and other devices, by using at least one of long-distance data communication methods including, for example, a wired LAN, a wireless LAN, Wi-Fi, Long-Term Evolution (LTE), 5G, satellite communication, and radio communication. For example, the server 2000 may perform data communication with the display device 3000 or the user's electronic device 4000.

The memory 2200 may include read-only memory (ROM) (e.g., programmable read-only memory (PROM), erasable programmable read-only memory (EPROM), electrically erasable programmable read-only memory (EEPROM)), non-volatile memory such as flash memory (e.g., a memory card or a solid-state drive (SSD)) and an analog recording type (e.g., a hard disk drive (HDD), a magnetic tape, or an optical disk), and volatile memory such as random-access memory (RAM) (e.g., dynamic random-access memory (DRAM) or static random-access memory (SRAM)).

The processor 2300 may control overall operations of the server 2000. For example, the processor 2300 may control overall operations of the display device 2000 for setting a private connection between user terminals, by executing one or more instructions of the program stored in the memory 2200. The processor 2300 may be included as one or more.

The memory 2200 may store one or more instructions and programs for causing the server 2000 to operate to process media content. For example, the memory 2200 may store a video analysis module 2210, an audio analysis module 2220, a text analysis module 2230, and a content navigation module 2240.

The processor 2300 may control overall operations of the server 2000. For example, the processor 2300 may control overall operations, performed by the server 200, of analyzing and navigating media content, by executing the one or more instructions of the program stored in the memory 2200. The processor 2300 may be included as one or more.

The one or more processors 2300 may include at least one of a central processing unit (CPU), a graphics processing unit (GPU), an accelerated processing unit (APU), a many integrated core (MIC), a digital signal processor (DSP), or a neural processing unit (NPU). The one or more processors 2300 may be implemented in the form of an integrated system on a chip (SoC) including one or more electronic components. Each of the one or more processors 2300 may be implemented as separate hardware (H/W).

The processor 2300 may perform video analysis by using the video analysis module 2210. Because descriptions related to the operations of the video analysis module 2210 have already been described with reference to the above-mentioned drawings, repeated descriptions are omitted for brevity.

The processor 2300 may perform audio analysis by executing the audio analysis module 2220. Because descriptions related to the operations of the audio analysis module 2220 have already been described with reference to the above-mentioned drawings, repeated descriptions are omitted for brevity.

The processor 2300 may perform text analysis by executing the text analysis module 2230. Because descriptions related to the operations of the text analysis module 2230 have already been described with reference to the above-mentioned drawings, repeated descriptions are omitted for brevity.

The processor 2300 may use the content navigation module 2240 to search for video frames or scenes corresponding to a user's intention to navigate the media content. The processor 2300 may use scene context data generated based on at least one of video analysis, audio analysis, or text analysis. Because descriptions related to the operations of the content navigation module 2240 have already been described with reference to the above-mentioned drawings, repeated descriptions are omitted for brevity.

The modules stored in the memory 2200 and executed by the processor 2300 are for convenience of description, but embodiments of the disclosure are not limited thereto. Other modules may be added to implement the above-described embodiments, one module may be divided into a plurality of modules distinguished according to detailed functions, and some of the above-described modules may be combined to form one module.

When a method according to one or more embodiments includes a plurality of operations, the plurality of operations may be performed by one processor or by a plurality of processors. For example, based on a first operation, a second operation, and a third operation being performed by the method according to one or more embodiments, the first operation, the second operation, and the third operation may all be performed by a first processor, or the first operation and the second operation may be performed by a first processor (e.g., a general-purpose processor) and the third operation may be performed by a second processor (e.g., an AI processor). An AI dedicated processor, which is an example of the second processor, may perform operations for training/inference of an AI model. However, embodiments of the disclosure are not limited thereto.

The one or more processors 2300 according to the disclosure may be implemented as a single-core processor or as a multi-core processor.

When the method according to one or more embodiments includes a plurality of operations, the plurality of operations may be performed by one core or by a plurality of cores included in one or more processors.

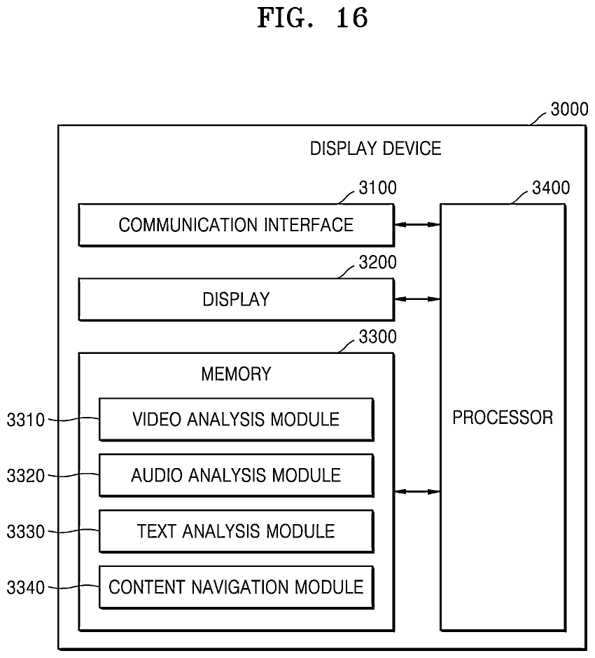

FIG. 16 is a block diagram of the display device 3000 according to one or more embodiments.

According to one or more embodiments, the display device 3000 may include a communication interface 3100, a display 3200, a memory 3300, and a processor 3400. The display device 2000 may include, but is not limited to, a TV, a smart monitor, a tablet PC, a laptop, a digital signage, a large display, and a 360-degree projector each including a display. The communication interface 3100, the memory 3300, and the processor 3400 of the display device 3000 perform the same operations as or similar operations to the communication interface 2100, the memory 2200, and the processor 2300 of the server 2000 of FIG. 15, respectively, and thus redundant descriptions thereof will be omitted.

The display 3200 may output an image signal to the screen of the display device 4000 under a control by the processor 3400. For example, the display device 3000 may output the media content through the display 3200.

According to one or more embodiments, operations of the sever 2000 may be performed by the display device 3000. The display device 3000 may obtain the media content, and perform at least one of video analysis, audio analysis, or text analysis on the media content.

The display device 3000 may obtain scene context data corresponding to video frames of the media content, based on at least one of video context data, audio context data, or text context data.

The display device 3000 may receive a user input (e.g., a natural language speech) and identify the user's intention for navigating the media content.

The display device 3000 may use the scene context data to identify a video frame corresponding to the user's intention, and may output the identified video frame.

As for other additional and detailed operations, performed by the display device 3000, of analyzing and navigating the media content, the operations of the server 2000 described above with reference to the previous drawings may be equally applied. Thus, a repeated description thereof will be omitted for brevity.

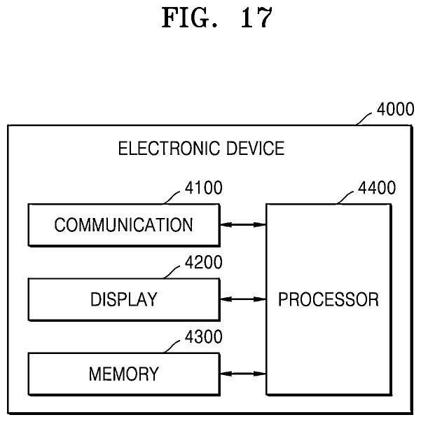

FIG. 17 is a block diagram of the electronic device 400 according to one or more embodiments.

According to one or more embodiments, the display device 4000 may include a communication interface 4100, a display 4200, a memory 4300, and a processor 4400. The electronic device 4000 refers to a user's electronic device described above with reference to the above-described drawings. The electronic device 4000 may be, for example, a desktop, a laptop, a smartphone, or a tablet, but embodiments of the disclosure are not limited thereto.

According to one or more embodiments, the user may edit the media content by using the electronic device 4000. The electronic device 4000 may receive information related to a user interface for editing media content from the server 2000 or the display device 3000. The electronic device 4000 may display the user interface for editing media content, and may receive a user input for editing media content from the user. The electronic device 4000 may transmit information about editing of the media content to the server 2000 or the display device 3000.

According to one or more embodiments, the user may receive a summary of a result of the editing of the media content through the electronic device 4000. The server 2000 may provide the electronic device 4000 with the summary of the result of the media content editing.

The disclosure provides a method of precisely navigating to a scene by receiving a natural language from a user who watches media content. Additional aspects will be set forth in part in the description which follows and, in part, will be apparent from the description, or may be learned by practice of the presented embodiments.

According to one or more embodiments, provided is a method, performed by a server, of providing media content.

The method may include obtaining media content including video data and audio data.

The method may include obtaining first context data related to a video by analyzing the video data.

The method may include obtaining second context data related to an audio by analyzing the audio data.

The method may include, based on the first context data and the second context data, generating scene context data corresponding to video frames of the media content.

The method may include determining a user intention for navigating the media content, based on a user input.

The method may include identifying at least one video frame corresponding to the user intention, based on the scene context data.

The method may include outputting the identified at least one video frame.

The media content may include text data.

The method may include obtaining third context data related to the text by analyzing the text data.

The generating of the scene context data may include generating the scene context data, further based on the third context data.

The obtaining of the first context data may include obtaining scene information by applying object recognition to at least some of the video frames of the video data.

The obtaining of the first context data may include generating at least one scene graph corresponding to at least one video frame, based on the scene information.

The obtaining of the first context data may include obtaining the first context data representing a context of a video, based on the at least one scene graph.

The obtaining of the second context data may include obtaining scene-sound information by applying at least one of voice recognition, sound event detection, or sound event classification to the audio data.

The obtaining of the second context data may include obtaining the second context data representing a context of the audio, based on the scene-sound information.

The obtaining of the third context data may include obtaining scene-text information by applying NLP to the text data.

The obtaining of the third context data may include obtaining the third context data representing a context of text, based on the scene-text information.

The determining of the user intention for navigating the media content may include performing ASR, based on the user input being speech.

The determining of the user intention for navigating the media content may include determining the user intention by applying a natural language understanding (NLU) algorithm to a result of the automatic speech recognition.

The method may include, based on a user input for selecting one video frame from among the output at least one video frame, allowing the media content to be played from the selected video frame.

The user input may include at least one keyword for editing the media content.

The identifying of the at least one video frame may include identifying a video frame corresponding to the at least one keyword, based on the scene context data.

The method may include providing a user interface for editing the media content.

The method may include providing a summary of a result of the editing of the media content.

According to one or more embodiments, provided is a server that provides media content.

The server may include a communication interface, a memory storing one or more instructions, and at least one processor configured to execute the one or more instructions.

The at least one processor may be configured to execute the one or more instructions to obtain media content including video data and audio data.

The at least one processor may be configured to execute the one or more instructions to obtain first context data related to a video by analyzing the video data.

The at least one processor may be configured to execute the one or more instructions to obtain second context data related to an audio by analyzing the audio data.

The at least one processor may be configured to execute the one or more instructions to, based on the first context data and the second context data, generate scene context data corresponding to video frames of the media content.

The at least one processor may be configured to execute the one or more instructions to determine a user intention for navigating the media content, based on a user input.

The at least one processor may be configured to execute the one or more instructions to identify at least one video frame corresponding to the user intention, based on the scene context data. The at least one processor may be configured to execute the one or more instructions to output the identified at least one video frame.

The media content may include text data.

The at least one processor may be configured to execute the one or

more instructions to obtain third context data related to text by analyzing the text data.

The at least one processor may be configured to execute the one or more instructions to generate the scene context data, further based on the third context data.

The at least one processor may be configured to execute the one or more instructions to obtain scene information by applying object recognition to at least some of the video frames of the video data.

The at least one processor may be configured to execute the one or more instructions to generate at least one scene graph corresponding to at least one video frame, based on the scene information.

The at least one processor may be configured to execute the one or more instructions to obtain the first context data representing a context of the video, based on the at least one scene graph.

The at least one processor may be configured to execute the one or more instructions to obtain scene-sound information by applying at least one of voice recognition, sound event detection, or sound event classification to the audio data.

The at least one processor may be configured to execute the one or more instructions to obtain the second context data representing a context of the audio, based on the scene-sound information.

The at least one processor may be configured to execute the one or more instructions to obtain scene-text information by applying NLP to the text data.

The at least one processor may be configured to execute the one or more instructions to obtain the third context data representing a context of the text, based on the scene-text information.

The at least one processor may be configured to execute the one or more instructions to perform ASR, based on the user input being a speech.

The at least one processor may be configured to execute the one or more instructions to determine the user intention by applying a natural language understanding (NLU) algorithm to a result of the automatic speech recognition.

The at least one processor may be configured to execute the one or more instructions to, based on a user input for selecting one video frame from among the output at least one video frame, allowing the media content to be played from the selected video frame.

The user input may include at least one keyword for editing the media content.

The at least one processor may be configured to execute the one or more instructions to identify a video frame corresponding to the at least one keyword, based on the scene context data.

The at least one processor may be configured to execute the one or more instructions to provide a user interface for editing the media content.

According to one or more embodiments, provided is a display device that provides media content.

The display device may include a communication interface, a display, a memory storing one or more instructions, and at least one processor configured to execute the one or more instructions.

The at least one processor may be configured to execute the one or more instructions to obtain media content including video data and audio data.

The at least one processor may be configured to execute the one or more instructions to obtain first context data related to a video by analyzing the video data.

The at least one processor may be configured to execute the one or more instructions to obtain second context data related to an audio by analyzing the audio data.

The at least one processor may be configured to execute the one or more instructions to, based on the first context data and the second context data, generate scene context data corresponding to video frames of the media content.

The at least one processor may be configured to execute the one or more instructions to determine a user intention for navigating the media content, based on a user input.

The at least one processor may be configured to execute the one or more instructions to identify at least one video frame corresponding to the user intention, based on the scene context data.

The at least one processor may be configured to execute the one or more instructions to enable the identified at least one video frame to be output on a screen of the display.

One or more embodiments can also be embodied as a storage medium including instructions executable by a computer such as a program module executed by the computer. A computer readable medium can be any available medium which can be accessed by the computer and includes all volatile/non-volatile and removable/non-removable media. Further, the computer readable medium may include all computer storage and communication media. The computer storage medium includes all volatile/non-volatile and removable/non-removable media embodied by a method or technology for storing information such as computer readable instruction code, a data structure, a program module or other data. Communication media may include computer readable instructions, data structures, or other data in a modulated data signal, such as program modules.

In addition, computer-readable storage media may be provided in the form of non-transitory storage media. The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

According to one or more embodiments, a method according to various disclosed embodiments may be provided by being included in a computer program product. The computer program product, which is a commodity, may be traded between sellers and buyers. Computer program products are distributed in the form of device-readable storage media (e.g., compact disc read only memory (CD-ROM)), or may be distributed (e.g., downloaded or uploaded) through an application store or between two user devices (e.g., smartphones) directly and online. In the case of online distribution, at least a portion of the computer program product (e.g., a downloadable app) may be stored at least temporarily in a device-readable storage medium, such as a memory of a manufacturer's server, a server of an application store, or a relay server, or may be temporarily generated.

While the disclosure has been shown and described with reference to exemplary embodiments thereof, it will be understood that various changes in form and details may be made therein without departing from the spirit and scope of the disclosure. Thus, the above-described embodiments should be considered in descriptive sense only and not for purposes of limitation. For example, each component described as a single type may be implemented in a distributed manner, and similarly, components described as being distributed may be implemented in a combined form.

The scope of the disclosure is indicated by the scope of the claims to be described later rather than the above detailed description, and all changes or modified forms derived from the meaning and scope of the claims and the concept of equivalents thereof should be interpreted as being included in the scope of the disclosure.

What is claimed is:

1. A method, performed by a server, of providing media content, the method comprising:
obtaining media content including video data and audio data;
obtaining first context data by analyzing the video data;
obtaining second context data by analyzing the audio data;
based on the first context data and the second context data, generating scene context data corresponding to a plurality of video frames of the media content;
determining a user intention for navigating the media content based on a first user input;
identifying a first at least one video frame of the plurality of video frames corresponding to the user intention based on the scene context data; and
outputting the identified first at least one video frame.

2. The method of claim 1, wherein the media content includes text data,
wherein the method further comprises obtaining third context data by analyzing the text data, and
wherein the generating of the scene context data comprises generating the scene context data, further based on the third context data.

3. The method of claim 2, wherein the obtaining of the first context data comprises:
obtaining scene information by applying object recognition to a second at least one video frame of the plurality of video frames;
generating at least one scene graph corresponding to the second at least one video frame, based on the scene information; and
obtaining the first context data representing context of the video data, based on the at least one scene graph.

4. The method of claim 3, wherein the obtaining of the second context data comprises:
obtaining scene-sound information by applying at least one of voice recognition, sound event detection, or sound event classification to the audio data; and
obtaining the second context data representing context of the audio data, based on the scene-sound information.

5. The method of claim 4, wherein the obtaining of the third context data comprises:
obtaining scene-text information by applying natural language processing to the text data; and
obtaining the third context data representing context of the text data, based on the scene-text information.

6. The method of claim 1, wherein the determining of the user intention for navigating the media content comprises:
performing automatic speech recognition (ASR), based on the first user input being speech; and
determining the user intention by applying a natural language understanding (NLU) algorithm to a result of the automatic speech recognition.

7. The method of claim 1, further comprising, based on a second user input for selecting one video frame from among the identified first at least one video frame, allowing the media content to be played from the selected video frame.

8. The method of claim 1,
wherein the first user input includes at least one keyword for editing the media content, and
wherein the identifying of the first at least one video frame comprises identifying a video frame of the plurality of video frames corresponding to the at least one keyword, based on the scene context data.

9. The method of claim 8, further comprising providing a user interface for editing the media content.

10. The method of claim 9, further comprising providing a summary of a result of the editing of the media content.

11. A server for providing media content, the server comprising:
a communication interface;
a memory storing one or more instructions; and
at least one processor configured to execute the one or more instructions,
wherein the at least one processor is further configured to execute the one or more instructions to:
obtain media content comprising video data and audio data;
obtain first context data by analyzing the video data;
obtain second context data by analyzing the audio data;
based on the first context data and the second context data, generate scene context data corresponding to a plurality of video frames of the media content;
determine a user intention for navigating the media content based on a first user input;
identify a first at least one video frame of the plurality of video frames corresponding to the user intention based on the scene context data; and
output the identified first at least one video frame.

12. The server of claim 11, wherein the media content includes text data, and
wherein the at least one processor is further configured to execute the one or more instructions to:
obtain third context data by analyzing the text data; and
generate the scene context data, further based on the third context data.

13. The server of claim 12, wherein the at least one processor is further configured to execute the one or more instructions to:
obtain scene information by applying object recognition to a second at least one video frame of the plurality of video frames;
generate at least one scene graph corresponding to the second at least one video frame, based on the scene information; and
obtain the first context data representing context of the video data, based on the at least one scene graph.

14. The server of claim 13, wherein the at least one processor is further configured to execute the one or more instructions to:
obtain scene-sound information by applying at least one of voice recognition, sound event detection, or sound event classification to the audio data; and
obtain the second context data representing context of the audio data, based on the scene-sound information.

15. The server of claim 14, wherein the at least one processor is further configured to execute the one or more instructions to:
obtain scene-text information by applying natural language processing to the text data; and
obtain the third context data representing context of the text data, based on the scene-text information.

16. The server of claim 11, wherein the at least one processor is further configured to execute the one or more instructions to:
perform automatic speech recognition (ASR), based on the first user input being speech; and
determine the user intention by applying a natural language understanding (NLU) algorithm to a result of the automatic speech recognition.

17. The server of claim 11, wherein the at least one processor is further configured to execute the one or more instructions to, based on a second user input for selecting one video frame from among the identified first at least one video frame, allowing the media content to be played from the selected video frame.

18. The server of claim 11, wherein
the first user input includes at least one keyword for editing the media content, and
the at least one processor is further configured to execute the one or more instructions to identify a video frame corresponding to the at least one keyword, based on the scene context data.

19. The server of claim 11, wherein the at least one processor is further configured to execute the one or more instructions to provide a user interface for editing the media content.

20. A non-transitory computer-readable recording medium storing one or more instructions, which, when executed by a processor of a server providing media content, causes the server to:
obtain media content comprising video data and audio data;
obtain first context data by analyzing the video data;
obtain second context data by analyzing the audio data;
based on the first context data and the second context data, generate scene context data corresponding to a plurality of video frames of the media content;
determine a user intention for navigating the media content based on a user input;
identify a first at least one video frame of the plurality of video frames corresponding to the user intention based on the scene context data; and
output the identified first at least one video frame.
